(19) United States
(12) Patent Application Publication
(10) Pub. No.: US 2014/0312610 A1
(43) Pub. Date: Oct. 23, 2014

(54) PIPE JOINT STRUCTURE

(71) Applicant: Yu-Chen Chiang, New Taipei City (TW)

(72) Inventor: Yu-Chen Chiang, New Taipei City (TW)

(21) Appl. No.: 13/864,854

(22) Filed: Apr. 17, 2013

(51) Int. Cl. F16L 19/00

(52) U.S. Cl. CPC F16L 19/005
USPC 285/89

(57) ABSTRACT

A pipe joint structure includes a connection head, an internal loop and a lock nut. One end of the connection head is disposed with a connection nut adapted to be in connection with other outside device, and another end thereof is disposed with a thread portion and an engagement portion adapted to insert in the tube, allowing the connection head to be coupled to the pipe. The internal loop and the lock nut are respectively engaged with the outer part of the pipe, where the internal loop can be fixed on the outer parts of the pipe and an insertion end of the engagement portion of the connection head, and the lock nut can be engaged with the thread portion of the connection head and covers the outer part of the internal loop fixedly as well. The locking can be carried out by using any tool (e.g. wrench) through the lock nut. Therefore, the lock nut tightly compresses the internal loop, and then the internal loop correspondingly and tightly compresses the thread portion of the connection head and the pipe at the position that they are coupled to each other, allowing the tight coupling of the connection head to the pipe.

### TECHNICAL FIELD OF THE INVENTION

The present invention relates to a pipe joint structure, and more particularly to a pipe joint structure capable of coupling a connection head to a pipe tightly without using special tools or fixtures.

### DESCRIPTION OF THE PRIOR ART

The connection between the current oil pipelines or the connection between a pipeline and other device in a vehicle is mainly completed through an oil pipe joint, and a conventional oil pipe joint is coupled to an oil pipeline in such a way that a metal loop is engaged with the outer part of the oil pipe joint at a position that the oil pipe joint is coupled to the oil pipeline after the oil pipe joint is coupled to the oil pipeline, and special clamping equipment or a fixture is then used to compress the metal loop tightly, thereby achieving the tight connection between the oil pipe joint and oil pipeline.

However, a conventional oil pipe joint can be coupled to an oil pipeline hermetically, but there are still some problems and deficiencies need to be overcome. For example, the metal loop engaged with the outer part of a conventional oil pipe joint at the position that the joint is coupled to an oil pipeline must be compressed tightly by means of special clamping equipment or a fixture such that the maintenance and use are confined, the operation steps thereof are complicated and more labor cost and time consumption are needed. In addition, once the metal loop mentioned above is compressed tightly, it is difficult to be loosen arbitrarily, and thus the metal loop must be destroyed first, so that the oil pipe joint can then be separated from the oil pipeline upon maintenance, and the worse, a new metal loop must be assembled again during the maintenance is carried out, causing the maintenance cost to be increased.

### SUMMARY OF THE INVENTION

The main object of the present invention is to provide a pipe joint structure, capable of coupling and fixing thereof to a device or pipe needing no special tool or fixture, where the pipe is disposed with internal and external threads. To achieve the object mentioned above, the present invention proposes a pipe joint structure, including a connection head, internal loop and lock nut. One end of the connection head is disposed with a connection nut adapted to be in connection with other outside device, and another end thereof is disposed with a thread portion and an engagement portion adapted to insert in the tube, allowing the connection head to be coupled to the pipe. The internal loop and lock nut are respectively engaged with the outer part of the pipe, where the internal loop can be fixed on the outer parts of the pipe and an insertion end of the engagement portion of the connection head, and the lock nut can be engaged with the thread portion of the connection head and covers the outer part of the internal loop fixedly as well. The locking can be carried out by using any tool (e.g. wrench) through the lock nut. Therefore, the lock nut tightly compresses the internal loop, and then the internal loop corrrespondly and tightly compresses the thread portion of the connection head and the pipe at the position that they are coupled to each other, allowing the tight coupling of the connection head to the pipe.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a perspective view of a pipe joint of the present invention;

FIG. 2 is an exploded view of a pipe joint of the present invention;

FIG. 3 is a perspective view of a pipe joint of the present inventing in the middle of assembly;

FIG. 3 is a perspective view of a pipe joint of the present inventing after assembly; and

FIG. 5 is a partly cross-sectional view of a pipe joint of the present invention.

### DETAILED DESCRIPTION OF THE PREFERRED EMBODIMENTS

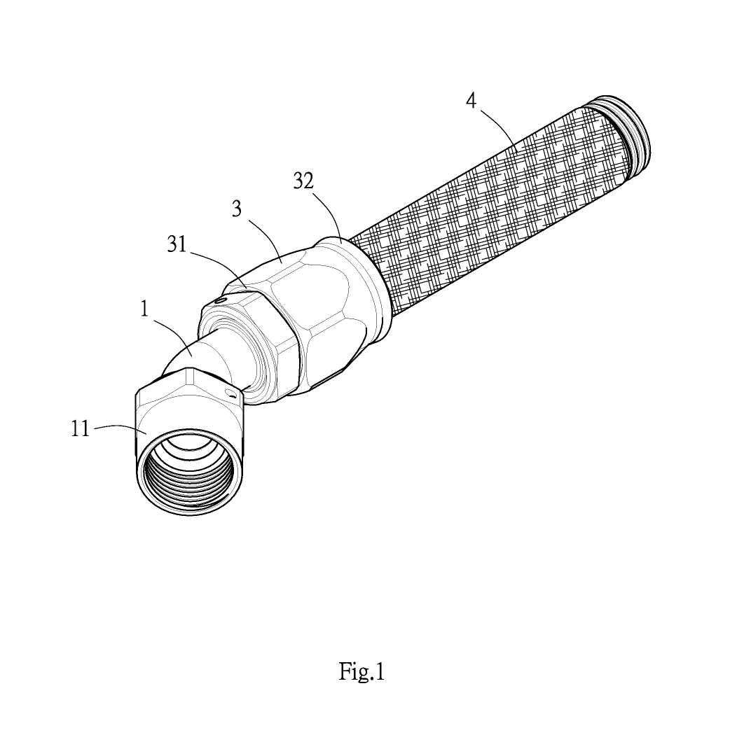

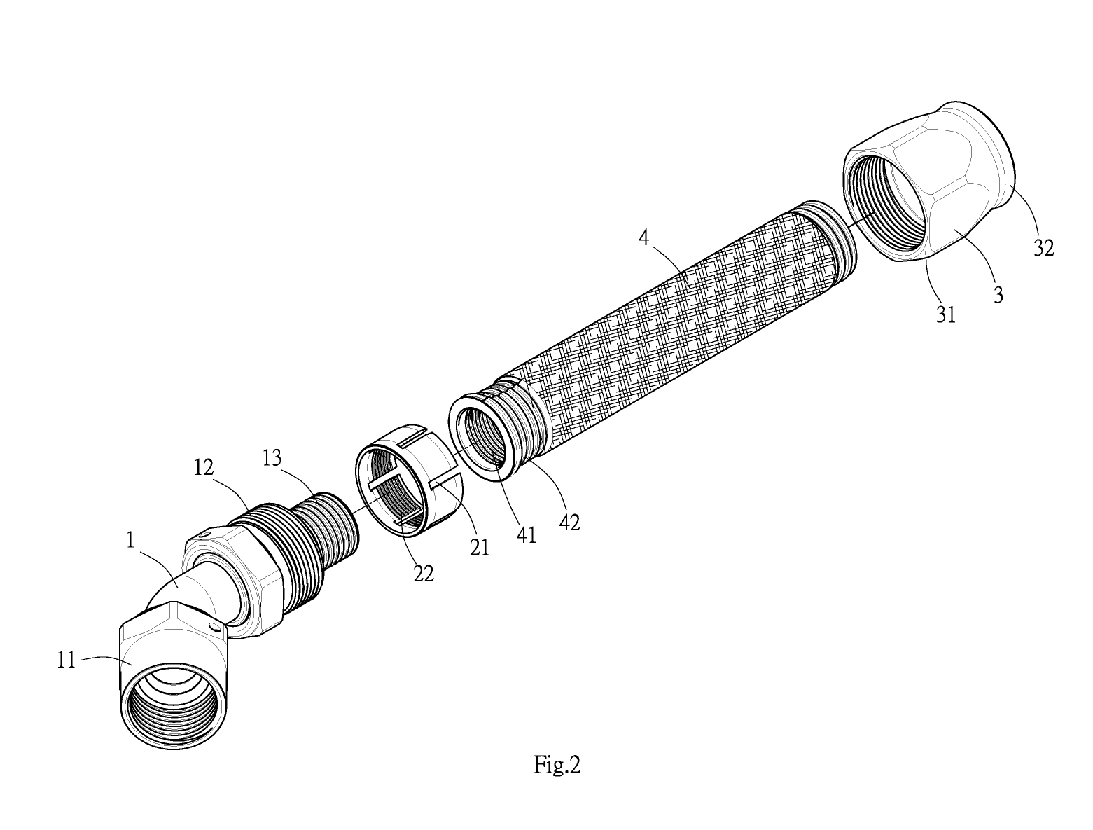

Referring to FIGS. 1 and 2, the present invention discloses a pipe joint structure, particularly, a pipe joint structure coupled to a preset pipe 4, where the pipe 4 is disposed with internal threads 41 and external threads 42. The pipe joint includes a connection head 1, internal loop 2 and lock nut 3.

The connection head 1 is disposed with a connection nut 11 on one end thereof and a thread portion 12 on another end thereof, and one end of the thread portion 12 of the connection head 1 is extended with a engagement portion 13, where the diameter of the engagement portion 13 is smaller than the one of the thread portion 12 and the engagement portion 13 can be inserted in the pipe 4.

The internal loop 2 may be engaged with the outer part of the pipe 4, and a plurality of slots 21 are disposed around the internal loop 2, allowing the internal loop 2 to be deformed elastically during outside compression.

The lock nut 3 is adapted to engage with the outer part of the pipe 4 and covers the internal loop 2. The lock nut 3 is disposed with an opening end 31 on one end thereof and a contraction end 32 on another end thereof, namely, the lock nut 3 is contracted gradually from the opening end 31 toward the contraction end 32. Furthermore, the opening end 31 of the lock nut 3 is disposed with internal threads 311 capable of engaging with the thread portion 12 of the connection head 1, and the contraction end 32 of the lock nut 3 can compress the internal loop 2 tightly correspondingly.

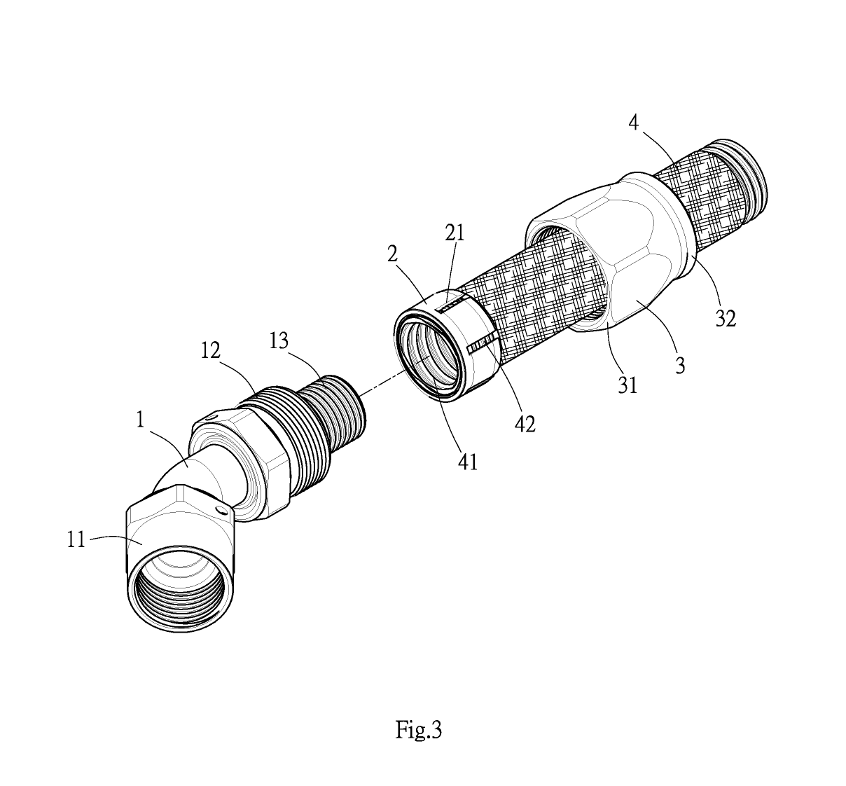

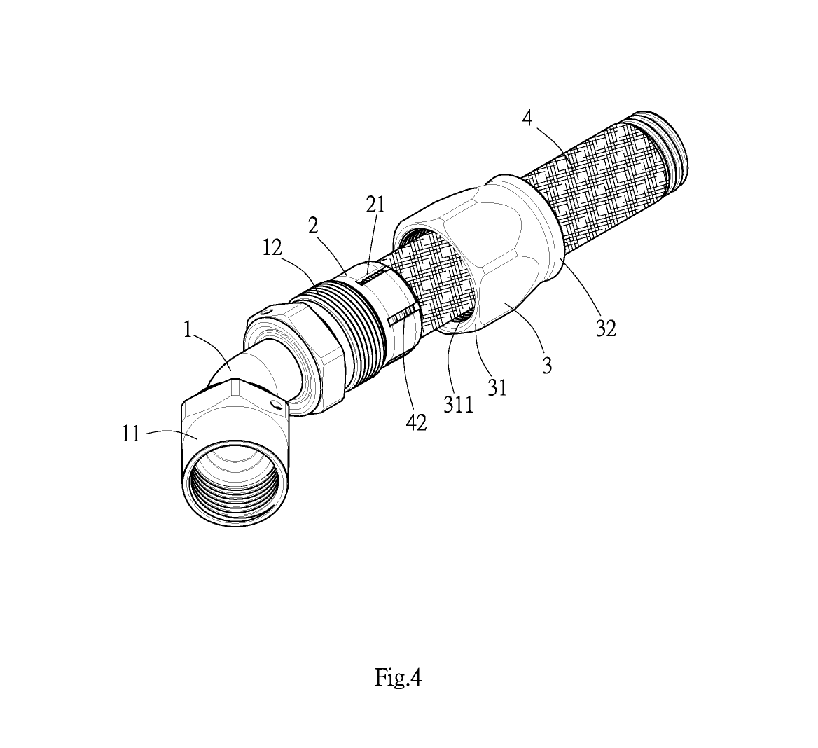

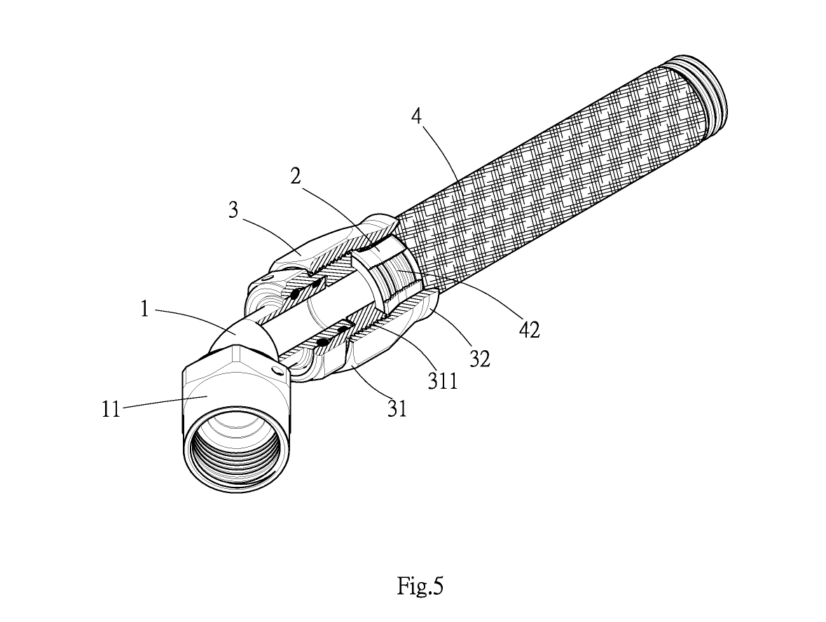

Referring to FIGS. 3, 4 and 5, in a preferred embodiment, the engagement portion 13 of the connection head 1 is disposed with external threads corresponding to the internal threads 41 of the pipe 4. The internal loop 2 and the lock nut 3 are respectively engaged with the outer part of the tube 4, where the internal loop 2 is also disposed with internal threads 22 corresponding to the external threads 42 of the tube 4, allowing the inner loop 2 to be fixed on the outer part of the pipe 4 at a position that the pipe 4 is coupled to the engagement portion 13 of the connection head 1. Furthermore, internal threads 311 disposed on the internal face of the lock nut 3 can be engaged with the thread portion 12 of the connection head 1, allowing the lock nut 3 to be fixed on the outer part of the pipe 4 and cover the outer part of the internal loop 2 as well.

It should be noted that the internal loop 2 is compressed by the contraction end 32 of the lock nut 3, causing it to be tightened when the lock nut 3 covers the outer part of the internal loop 2, and the internal loop 2 then compresses to tighten the engagement portion 13 of the connection head 1 and the pipe 4 relatively at the position that they are coupled to each other, allowing the connection head and the pipe 4 to be coupled to each other closely. In addition, a user may use any tool (e.g. a wrench or a monkey wrench) to process the locking through the lock nut 3 without using any special clamping equipment or fixture, allowing the processing complexity and production cost to be reduced. Furthermore, the pipe joint of the present invention can be detached and assembled repeatedly, thereby reducing the assembly or maintenance cost because it can be detached or assembled through the lock nut 3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

I claim:

1. A pipe joint structure, comprising:
a connection head, one end thereof being disposed with a thread portion, one end of said thread portion being extended with an engagement portion, a diameter of said engagement portion being smaller than a diameter of said thread portion, and said engagement portion being allowed to be inserted in a pipe;
an internal loop, engaged with an external part of said pipe and disposed with a plurality of slots;
a lock nut, engaged with said internal loop, one end thereof being disposed with an opening end and another end thereof being disposed with a contraction end, and said opening end being disposed with internal threads capable of being engaged with said thread portion of said connection head and said contraction end being capable of compressing said internal loop tightly correspondingly.

2. The structure according to claim 1, wherein said lock nut is contracted gradually from said opening end toward said contraction end.

3. The structure according to claim 1, wherein said another end of said connection head is disposed with a connection nut.

4. The structure according to claim 1, wherein said pipe is an oil pipe.

5. The structure according to claim 1, wherein said engagement portion is disposed with external threads.

6. The structure according to any one of claims 5, wherein said pipe is disposed with internal threads.

7. The structure according to claim 6, wherein said pipe is disposed with external threads, and said internal loop is also disposed with internal threads corresponding to said external threads of said pipe.
